(19) United States
(12) Patent Application Publication
(10) Pub. No.: US 2026/0003176 A1
(43) Pub. Date: Jan. 1, 2026

(54) Microscope, slide reader and method for microscopy

(71) Applicant: Carl Zeiss Microscopy GmbH, Jena (DE)

(72) Inventors: Daniel Schwedt, Jena (DE); Tiemo Anhut, Jena (DE)

(21) Appl. No.: 19/252,742

(22) Filed: Jun. 27, 2025

(30) Foreign Application Priority Data
Jun. 29, 2024 (DE) 10 2024 118 477.9

(51) Int. Cl. G02B 21/16; G01N 21/64; G02B 21/08; G02B 21/26

(52) U.S. Cl. CPC G02B 21/16; G01N 21/6458; G02B 21/08; G02B 21/26; G01N 2021/6463; G01N 2201/0638; G01N 2201/105

(57) ABSTRACT

A microscope having a light source for transmitting excitation light, an illumination beam path comprising a cylindrical optics unit for shaping the excitation light to form an illumination line and a scanning unit for linearly scanning the sample, a detection beam path for guiding emission light radiated by the sample onto a camera for recording images of the sample, and a control unit for controlling at least the scanning unit and/or the camera and for evaluating measurement data from the camera, the control unit being configured to synchronize respective readout regions on a sensor surface of the camera with a position of the excitation light in a sample region. For varying an axial pose of a plane in the sample optically conjugate to a sensor surface of the camera, the detection beam path comprises a controllable optics unit with variable refractive power, which is effective for the entire emission light that has propagated in the detection beam path to the camera.

The current application claims the benefit of German Patent Application No. 10 2024 118 477.9, filed on 29 Jun. 2024, which is hereby incorporated by reference.

In a first aspect, the invention relates to a microscope according to the preamble of claim 1. In further aspects, the invention relates to a slide reader and a method for microscopy according to the preamble of claim 20.

A generic microscope comprises at least the following components: a light source for transmitting excitation light, an illumination beam path having an illumination objective for guiding the excitation light onto or into a sample, the illumination beam path comprising a cylindrical optics unit for shaping the excitation light to form an illumination line and a scanning unit for linearly scanning the sample with the excitation light, a detection beam path having a microscope objective for guiding emission light radiated by the sample onto a camera, the camera for recording images of the sample, and a control unit for controlling at least the scanning unit and/or the camera and for evaluating measurement data from the camera, the control unit being configured to synchronize respective readout regions on a sensor surface of the camera with a position of the excitation light in a sample region as defined by the scanning unit.

In a generic method, at least the following method steps are carried out: a sample is linearly illuminated and scanned with excitation light by an illumination objective, emission light radiated by the sample as a consequence of being illuminated with the excitation light is guided in the direction of a camera via a microscope objective, and images of the sample are recorded by the camera, wherein respective readout regions on a sensor surface of the camera are synchronized with a position of the excitation light on the sample.

A generic microscope and a generic method are known for example from WO 2023117236 A1. [MAC2022] discloses a use of a resonantly operated electrically tunable lens (ETL) in the illumination beam path of a line-scanning confocal microscope.

Confocal microscopy methods are widely used in biomedical research in order to produce high-contrast images of three-dimensional microscopic samples with fluorescent tags. For this purpose, a so-called confocal stop is arranged in a plane conjugate to the focal plane of the microscope objective. This stop has the effect that fluorescence radiation generated outside the focal plane is prevented from propagating to the sensor, with the result that substantially light from the sample plane is detected. This method is generally called optical sectioning. In order to generate a two-dimensional image, a laser spot that excites the fluorescence radiation is scanned over the sample, for example by means of scanning mirrors. Such an image is often referred to as an optical section.

Owing to image build-up by way of scanning, this method is comparatively slow and only attains frame rates in the range of a few Hz. Moreover, if a three-dimensional image representation of the sample is intended to be generated from a plurality of optical sections, the sample has to be displaced axially relative to a focal plane of the objective between the two-dimensional image recordings. This is done by generally raising either the sample stage or the objective including the entire objective turret. Since this necessitates accelerating and moving comparatively large masses, these manipulations take a comparatively long time, typically a few hundred milliseconds, and may additionally cause vibrations.

However, many applications in microscopy, especially the examination of living samples, require the three-dimensional data to be recorded significantly faster, especially if the intention is to examine fast time-dependent processes in the sample (cell, cell conglomerates, microorganisms such as larvae, etc.).

A problem addressed by the invention can be considered that of providing a microscope, a slide reader and a method for microscopy which enable particularly rapid recording of microscopic images of a sample at different axial depths.

This problem is solved by the microscope having the features of claim 1, by the slide reader having the features of claim 19 and by the method having the features of claim 20.

The microscope of the type specified above is developed according to the invention by the fact that for the purpose of varying an axial pose of a plane in the sample optically conjugate to a sensor surface of the camera, the detection beam path comprises a controllable optics unit with variable refractive power, which is effective for the entire emission light that has propagated in the detection beam path to the camera.

The method of the type specified above is developed according to the invention by the fact that an axial pose of a plane in the sample optically conjugate to a sensor surface of the camera is set by a controllable optics unit with variable refractive power, which is effective for the entire emission light that has propagated to the camera.

The slide reader according to the invention comprises a microscope according to the invention.

The microscope according to the invention can be configured in particular to perform the method according to the invention. The methods according to the invention can be performed in particular using the microscope according to the invention. Advantageous exemplary embodiments of the microscope according to the invention and preferred variants of the method according to the invention are described below, in particular with reference to the dependent claims and the figures.

The excitation light, which can also be referred to as illumination light, is electromagnetic radiation, preferably in the visible range and adjacent ranges. In essence, lasers are conceivable as a light source for the invention, but other light sources, for example LED light sources, are also possible. In advantageous variants of the invention, linear or non-linear states that lead to the emission of photons are excited in a sample by way of the excitation light. That means that expediently use is made of light sources that are capable of exciting the desired states in the sample linearly or non-linearly. For example, dye molecules that have been used to prepare the samples to be examined are excited to transmit fluorescence by a 1-photon process or a multiphoton process, for example a 2-photon process.

In typical exemplary embodiments, the microscope is a fluorescence microscope, and the method is a method for fluorescence microscopy.

With regard to the samples to be examined, there is no restriction, in principle. However, the invention can be used particularly advantageously in the examination of biological samples.

The feature whereby the control unit is configured to synchronize respective readout regions on a sensor surface of the camera with a position of the excitation light in a sample region as defined by the scanning unit is understood to mean that the control unit is configured to control the camera and/or the scanning unit in such a way that the desired synchronization is achieved. It is consequently possible that the control unit controls the camera, and the camera in turn controls the scanning unit or is coupled to the latter. It is also possible that the control unit controls the scanning unit, and the scanning unit controls the camera or is coupled to the latter. Which components out of camera or control unit are “master” or “slave” during the control is consequently unimportant. For example, scanning curves for controlling the scanner can be stored in a memory, and the camera parameters determine the scanning curve that needs to be traversed. Moreover, the camera can trigger this process.

A spatial region on the object side of the illumination objective, in which a sample can be arranged, for example in a sample holder that is mounted on an x-y displacement stage, is also referred to as sample region within this description. In this sense, the terms sample and sample region are used synonymously.

The term illumination beam path denotes all optical beam-guiding and beam-modifying components, for example an illumination objective, a microscope objective, lenses, mirrors, prisms, gratings, filters, stops, beam splitters, modulators, e.g. spatial light modulators (SLM), by means of which and via which the excitation light from the light source is guided to the sample to be examined. Beam-modifying components can also comprise dispersive and in particular diffractive elements. Commercially available microscope objectives can be used, in principle.

In particular, the controllable optical unit with variable refractive power is not part of the illumination beam path.

The term cylindrical optics unit denotes an optical component or an optical assembly having a plurality of optical components that modifies, typically focuses, incident light differently in the two directions that are perpendicular to each other and to the optical axis. A typical example is given by a cylindrical lens that focuses incident light in only one of the two lateral directions while transmitting it substantially unchanged in the perpendicular direction. A substantially linear distribution of the excitation light, which is created by a cylindrical optics unit, is also referred to as an illumination line or linear focus.

The scanning unit serves to move the illumination line provided by the cylindrical optics unit through the sample or the sample region in a direction transversely to the direction of extent of the illumination line, and thus to linearly scan the sample. For example, the scanning unit comprises a scanner. Since scanning need only be performed in one direction, it is sufficient for the scanner to be capable of one-dimensional scanning. For example, an illumination line extending in the x-direction is scanned in the y-direction perpendicular thereto. Advantageously, the scanning unit and/or the scanner are/is arranged in a pupil plane or in the vicinity of a pupil plane of the illumination beam path.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the respective components, for example SLMs, each have a finite extent in the direction of the optical axis.

The term detection beam path denotes all beam-guiding and beam-modifying optical components, for example objectives, lenses, mirrors, prisms, gratings, filters, stops, beam splitters, modulators, e.g. spatial light modulators (SLMs), by means of which and via which the detection light is guided from the sample to be examined to the camera. The illumination objective of the illumination beam path and the microscope objective of the detection beam path can advantageously be one and the same microscope objective. That may be the case for reflected-light microscopy, for example, in which the sample is illuminated and observed from one and the same direction. In principle, however, it is also possible that the detection beam path has a separate microscope objective.

The emission light is electromagnetic radiation that is radiated by the sample as a consequence of being illuminated with the excitation light. Radiating means that the emission light comes from the sample. The emission light can also be referred to as detection light. The emission light can be reflected back off the sample or can be light that is transmitted through the illuminated sample. In comparison with the excitation light, the emission light can typically be red-shifted fluorescence from fluorescent markers used to prepare the sample.

The camera is a two-dimensionally spatially resolving detector and can be a CCD, CMOS or SPAD array camera, for example. In the invention, the camera is located in the non-descanned beam path.

The term control unit denotes all hardware and software components which interact with the components of the microscope according to the invention for the intended function thereof. In particular, the control unit can comprise a computing device, for example a PC, and a camera controller. The computer resources of the control unit can be distributed among a plurality of computers and optionally a computer network, in particular also via the Internet. The controller can have in particular customary operating devices and peripherals, such as mouse, keyboard, screen, storage media, joystick, Internet connection. The controller can in particular read the image data from the camera and can also be configured and serve to control the light source.

According to the invention, the control unit is configured for controlling at least the scanning unit and the camera and for synchronizing a readout region on a sensor surface of the camera with a position of the excitation light as defined by the scanning unit. The requisite functionality of the camera means for example that, depending on the control of the camera, only the pixels of one line or the pixels of a plurality of adjacent lines are read out. Being synchronized means readout of respectively that pixel line or those adjacent pixel lines on the sensor surface of the camera which are optically conjugate to regions in the sample which are illuminated with the illumination line at the relevant point in time. The functionality of reading out a defined number of lines, with the readout region moving across the camera chip during an image recording, is referred to as “rolling shutter” and is a camera property. For example, a “rolling shutter” allows defined regions of the camera sensor to be read out, in particular only these regions that run over the camera sensor. Optionally, this functionality must be implemented for a specific camera sensor.

Expediently, the camera is arranged in the detection beam path in such a way that the sensor surface of the camera is perpendicular to the optical axis of the detection beam path and that, moreover, the pixel lines of the camera lie parallel to the linear regions of the emission light that can be traced back in each case to the linear illumination of the sample.

Varying an axial pose is understood to mean that the pose of a plane perpendicular to the optical axis and optically conjugate to the plane of the sensor surface of the camera is varied.

The feature whereby the controllable optics unit with variable refractive power is effective for the entire emission light that has propagated in the detection beam path to the camera is understood to mean that the entire emission light guided via the detection beam path to the camera is influenced by the controllable optics unit. In this sense, the controllable optics unit with variable refractive power acts uniformly on the entire emission light that is guided in the detection beam path to the camera. Phrased differently, one could say that all beams that are guided from the microscope objective to the sensor surface of the camera traverse one and the same controllable optics unit with variable refractive power.

The invention is initially based on the insight that a linear illumination focus has a greater depth of field than a point focus known from the confocal laser scanning microscope. The cross-sectional area of a punctiform beam waist increases quadratically with distance from the focal plane, whereas that of a linear focus only increases linearly. Accordingly, the energy density of the excitation radiation remains comparatively high within a larger axial range in the case of a linear focus.

Given a focal position of the illumination beam path in the sample, a fundamental concept of the invention can now be considered that of varying a focal position of the detection beam path by way of slightly detuning the detection beam path. Since—as explained—the energy density of the excitation light is comparatively high within a larger axial range for a linear focus, this is possible without having to accept significant losses in the image brightness.

Thus, images from planes located at different depths within the sample can be obtained without needing to modify a distance of the sample relative to the microscope objective by actuating a z-drive. Hence, the detection beam path and the camera are configured to record images of an axial sample plane that is defined by the variable focal length optics unit.

The microscope according to the invention and the method according to the invention provide a potentially very fast imaging method for creating optical sections for fluorescence microscopy. A refocusing of the sample, and consequently a modification of the axial pose of the respectively measured sample planes, is potentially possible within very short times, for example in less than ten milliseconds.

Expediently, the slight variation of the focusing quantitatively corresponds to an axial interval of a few depths of field of the microscope objective of the detection beam path in the sample, within which the energy density of the excitation light is sufficiently high.

For example, the optics unit with variable refractive power can be designed such that it is possible to vary the axial depth of a focal region of the detection beam path in the sample region by more than four times a depth of field of the detection beam path in the sample region. Significant advantages in terms of speed when recording three-dimensional images, for example by a factor of 10, can be obtained as a result.

A significantly accelerated image recording with optical sectioning can advantageously be achieved for the slide scanner or slide reader according to the invention, which is generally used to examine non-living specimens. Latency times during axial focusing can be significantly reduced or removed entirely, and so for example a large substantially two-dimensional sample can be scanned quickly using a tiling method. Advantageously, a respective optimal focal plane can be set quickly in each case. Furthermore, the invention enables imaging along a plane situated obliquely in the sample or along some other geometric figure such as a one-dimensional saddle. This can be done by expediently coordinating the scanning movement with the setting of the controllable optics unit with variable refractive power.

In one particularly preferred exemplary embodiment of the microscope according to the invention, the optics unit with variable refractive power is arranged in a pupil plane. That is based on the further insight of the invention that an optomechanically accessible pupil plane can be created without complication in the detection beam path. A pupil plane is generally a preferred plane for manipulating the wavefront of the light, since the Fourier transform of the focal plane or of the image plane is present here. Accordingly, this plane is well suited to generating a slight variation of the focusing, i.e. a slight defocus, which is effective exclusively in the detection beam path. It can be sufficient to arrange the optics unit with variable refractive power in the vicinity of a pupil plane. The losses in image quality caused by positioning the optics unit with variable refractive power outside the pupil plane are often acceptable.

In principle, it may be possible for the optics unit with variable refractive power to comprise a controllable lens changer having a plurality of lenses with varying refractive power or to be realized by such a lens changer. However, since such lens changers are comparatively slow, such solutions tend not to be chosen here. Preferably, a time that the optics unit with variable refractive power requires in order to adjust the refractive power is shorter than a time required by an x-y displacement stage in order to laterally adjust a region of the sample that is imaged onto the camera between the recording of two images.

With regard to the switching times, preference is given to exemplary embodiments in which the optics unit with variable refractive power comprises a controllable deformable mirror (DM), an adaptive lens and/or an electronically tunable lens (ETL) or is realized by one or more of such components. These optical components make it possible to accomplish the adjustment of the focal position within times of less than 10 ms. ETLs that satisfy these demands are commercially available for example from Optotune Switzerland AG. Latencies resulting from movement of a focus drive can thus be reduced to a minimum. Moreover, the linear scanning of the sample according to the invention and the synchronization of the scanning speed with the speed of the rolling shutter of the camera enable a fast two-dimensional, confocal image recording at up to 100 fps (fps=frames per second). Given a residual latency of 10 ms, this results in a net frame rate of 50 fps in the case of a three-dimensional image recording. The refocusing during movement of the x-y sample stage between the recordings of the partial images thus abates in the case of a slide scan using the tiling method. Particularly preferably, the optics unit with variable refractive power can also comprise a controllable gravity-compensated liquid lens (GCLL) or be realized by a controllable gravity-compensated liquid lens (GCLL). These components are commercially available from Optotune Switzerland AG. The value of 100 fps applies only to a situation in which the entire camera chip is read out. However, it is also possible to read out only a few lines, which then proceeds faster for instance according to the ratio of the lines read out relative to the total number of lines. In the limiting case, it is also possible to let the scanner rest, and to scan a sample using the x-y stage. This is also referred to as “towel scanning”. The fast axial setting according to the invention proves to be very advantageous for this.

In preferred variants of the method according to the invention, the optics unit with variable refractive power is also used for correcting aberrations. That can be realized for example if the optics unit with variable refractive power supplementarily or alternatively comprises a spatial light modulator (SLM), for example a phase-modulating SLM, and/or an adaptive lens or is realized by one or more of these components. If aberrations, in particular spherical aberrations, are corrected, the axial adjustment range can also be increased.

In principle, the illumination beam path and the detection beam path can each have a separate tube lens. In one preferred configuration, the illumination beam path and the detection beam path comprise a common tube lens and the excitation light and the emission light pass through the same tube lens and optionally also the same intermediate image plane. A scanning optics unit in the illumination beam path can then advantageously also serve to provide in the detection beam path a pupil plane for the settable optics unit with variable refractive power. In this variant, the scanning unit of the illumination beam path is upstream of a main beam splitter, and the settable optics unit with variable refractive power is in the detection beam path downstream of the main beam splitter.

The cylindrical optics unit, the scanning unit, a main beam splitter, a scanning optics unit, the optics unit with variable refractive power and the camera can advantageously be arranged in an illumination/detection module coupled to a camera port, preferably exactly one camera port, of a microscope stand. The microscope stand contains the microscope objective and a tube lens for generating the intermediate image plane. Coupling to a single camera port has the effect that establishing and releasing the connection between the illumination/detection module and the microscope stand is of particularly simple design. A camera port can be understood to mean a mechanical-optical interface that serves to mechanically connect e.g. an illumination/detection module to the microscope stand.

The cylindrical optics unit can comprise at least a first cylindrical lens for generating the linear illumination. A settable stop for setting a numerical aperture of the cylindrical optics unit can be present upstream of the cylindrical optics unit in the illumination beam path. This one settable stop can serve to set a width of the illumination line in a pupil plane or an intermediate image plane.

Alternatively or supplementarily, the cylindrical optics unit can comprise at least one further cylindrical lens that is optionally introducible into the beam path and that serves to reduce a length of the linear focal region in its direction of extent in a pupil plane or an intermediate image plane. A reduction in the length of the linear focal region in the pupil plane leads to a focal region with a greater axial extent in the sample region and hence to a larger region that is to be scanned using the controllable optics unit with variable refractive power.

In principle, it would also be possible for the cylindrical optics unit to comprise a lens changer having a plurality of further cylindrical lenses with varying refractive power that are each optionally introducible into the beam path and that serve to varyingly reduce a length of the linear focal region in its direction of extent in a pupil plane or an intermediate image plane. Supplementarily or alternatively, the illumination beam path upstream of a main beam splitter can comprise a settable optics unit with variable refractive power for setting a length of the linear focal region in its direction of extent in a pupil plane or an intermediate image plane.

In one preferred variant, the illumination beam path comprises a settable stop for setting a length of the linear focal region in its direction of extent in a pupil plane or an intermediate image plane. The settable stop can expediently be arranged between the cylindrical optics unit and the light source, for example in a focal plane of the cylindrical optics unit.

In one preferred variant, the cylindrical optics unit generates a linear illumination in a back focal plane of the microscope objective. However, it is also possible for the illumination beam path between the cylindrical optics unit and the scanning unit to comprise a spherical lens. In this case, the cylindrical optics unit can generate a linear focus of the excitation light in an intermediate image plane provided by the spherical lens. A settable field stop can be arranged in the intermediate image plane provided by the spherical lens, and can be used to set the size of the field illuminated in the sample.

In order to avoid light losses at a stop, it is preferred if the illumination beam path upstream of the cylindrical optics unit comprises a settable telescope optics unit or a zoom optics unit for setting a field size or for setting an illumination of the cylindrical optics unit.

Finally, it is also possible for the illumination beam path upstream of a main beam splitter to comprise a controllable optics unit with variable refractive power for setting an axial depth of the linear focus of the excitation light in the sample. This settable optics unit with variable refractive power in the illumination beam path can be realized for example once again by an ETL, but also by any other of the components proposed for the controllable optics unit with variable refractive power that is present according to the invention in the detection beam path. The control unit can advantageously be configured for controlling the controllable optics unit with variable refractive power in the illumination beam path, in particular in coordination with the control of the optics unit with variable refractive power in the detection beam path.

In one variant of the method according to the invention, the optics unit with variable refractive power in the illumination beam path is operated synchronously with the optics unit with variable refractive power in the detection beam path, in such a way that a focal volume of the detection beam path is situated at an axial depth in the sample region in which a focal volume of the illumination light is situated. Generally, the term focal volume is intended to denote that volume region in which the excitation light is focused. Formally, the focal volume can be defined as a volume region in the region of the sample in which an intensity of the excitation light is greater than a limit value to be defined.

A spatial light modulator for modulating the excitation light in a sample plane can be arranged in the illumination beam path in a pupil plane. One advantageous development of the microscope is characterized in that a spatial light modulator for modulating the excitation light in the back focal plane of the microscope objective is arranged in the illumination beam path in an intermediate image plane.

The detection beam path in a pupil plane or in the vicinity of a pupil plane can comprise a detection scanning unit, in particular a one-dimensional detection scanning unit, that is synchronized with the scanning unit and the camera. The detection scanning unit is expediently configured for scanning a linear distribution of the emission light in a direction transversely with respect to a direction of extent of the linear distribution. For this purpose, the detection scanning unit advantageously comprises a scanner, in particular a one-dimensional scanner.

At least one of the scanners of the scanning unit and/or of the detection scanning unit can be a galvanometric scanner or a MEMS scanner.

The detection scanning unit in the detection beam path is expediently operated in a manner synchronized with the scanning unit and the camera. Particularly preferably, the detection scanning unit is operated at the same speed and with the same phase angle as the scanning unit. Operating the scanning unit and the detection scanning unit at the same speed and with the same phase angle is understood to mean that the maximum deflections of the scanning unit and of the detection scanning unit, i.e. the maximal deflections of the respective scanner mirrors in particular, are traversed at the same times, and the respective centre positions of the angular position are also traversed at the same times.

The same phase is understood to mean that in the event of a small deflection of the illumination pattern by the scanning unit and a consequential small deflection of the distribution of the emission light on the sensor surface of the camera, for example in the positive y-direction on the sensor surface of the camera, this distribution of the emission light is also advanced a certain amount in the same direction as a result of the effect of the detection scanning unit. A corresponding statement applies to displacements in the negative y-direction.

Thus, the detection scanning unit can be operated such that a non-optical enlargement is achieved on the sensor surface of the camera. This non-optical enlargement is given quantitatively by the ratio of the path lengths on the sensor surface of the camera in the y-direction caused by the effect of the scanning unit on the one hand and the effect of the detection scanning unit on the other.

In one preferred variant, an enlargement, in particular a non-optical enlargement, of the detection beam path provided by the detection scanning unit is large enough that measurement data from camera pixels in a direction transverse to the direction of extent of the linear distribution of the emission light are evaluable using image scanning methods.

In a further advantageous variant of the method according to the invention, the excitation light is modulated along the direction of extent of the linear illumination, measurement data of the camera pixels in the direction of the direction of extent of the linear illumination are evaluated by evaluation methods of structured illumination microscopy (SIM), and measurement data of the camera pixels in a direction transverse to the direction of extent of the linear illumination are evaluated in an image scanning method.

In structured illumination microscopy, different light patterns are radiated onto the sample and the images respectively measured are computed to form a result image with a higher resolution in comparison with the individual raw images. In image scanning methods, in essence measurement data from specific camera pixels are combined (pixel reassignment), with the result that an increase in the resolution is achieved. An increase in the resolution can thus be attained in both coordinate directions. For details in this respect reference is made to the same applicant's patent application DE102024108046.9, which was filed earlier and has not yet been published.

In a further preferred exemplary embodiment, a controllable x-y displacement stage, on which the sample is arrangeable, is present for the purpose of laterally varying a position of the sample relative to the microscope objective. The control unit can expediently be configured for controlling the x-y displacement stage and, in addition, for a plurality of positions of the x-y displacement stage, to record an overview image (tiling mode) of a sample composed of individual images and to assign to each individual image or to individual x-y positions therein a setting for the optics unit with variable refractive power, said setting being determined on the basis of image data of the relevant individual image.

In one preferred variant of the method, a focus setting map is determined, which in each case assigns x-y positions in an imaged field to a setting of the optics unit with variable refractive power by virtue of the fact that, for x-y positions which lie between the positions for which a setting for the optics unit with variable refractive power that has been determined on the basis of the overview image is present, a setting for the optics unit with variable refractive power is interpolated from values for adjacent x-y positions for which settings for the optics unit with variable refractive power that have been determined from the overview image are present.

Advantageously, upon moving to partial image positions, especially in the case of a slide scanner, focus values stored in the focus setting map can be set by the optics unit with variable refractive power, optionally with the aid of a z-focus drive of the microscope stand.

Further advantages and features of the invention are explained below in association with the appended figures, in which:

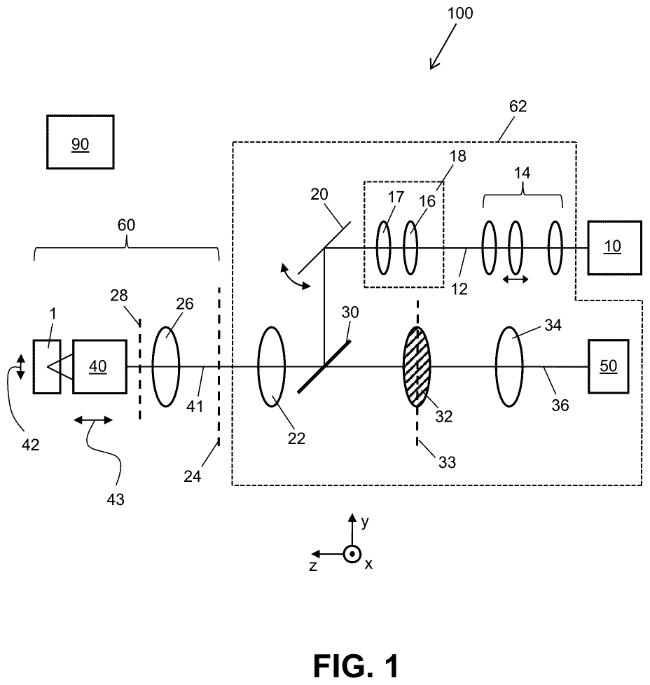

FIG. 1: shows an exemplary embodiment of a microscope according to the invention;

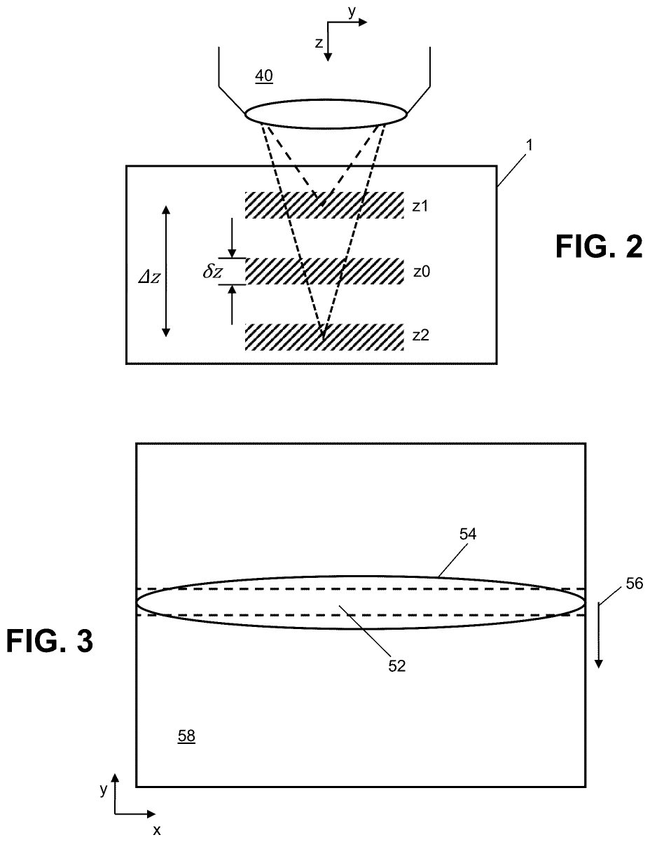

FIG. 2: shows a partial view of the microscope from FIG. 1 for elucidating essential properties of this microscope;

FIG. 3: shows a schematic view of a sensor surface of a camera used; and

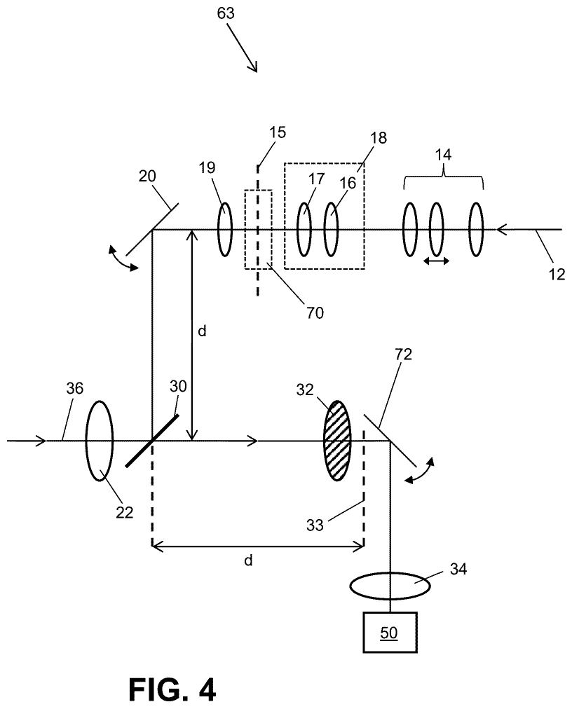

FIG. 4: shows a partial view of a variant of the microscope according to the invention from FIG. 1.

Identical and identically acting components are generally provided with the same reference signs in the figures.

A first exemplary embodiment of a microscope 100 according to the invention will be explained with reference to schematic FIGS. 1 to 3. According to the invention, the microscope 100, which can be part of a slide reader according to the invention, for example, initially includes a light source 10 for transmitting excitation light 12 and an illumination beam path having an illumination objective 40 for guiding the excitation light 12 into a sample region, in which a sample 1 is shown by way of example. According to the invention, the illumination beam path comprises a cylindrical optics unit 18 for shaping the excitation light 12 to form an illumination line and a scanning unit 20 for linearly scanning the sample 1 with the excitation light 12. Furthermore, according to the invention, the microscope 100 includes a camera 50 for recording images of the sample 1 and a detection beam path having a microscope objective 40 for guiding emission light 36 radiated by the sample 1 onto the camera 50. The illumination objective 40 and the microscope objective 40 are one and the same objective. According to the invention, a control unit 90 for controlling at least the scanning unit 20 and/or the camera 50 and for evaluating measurement data from the camera 50 is then present. According to the invention, the control unit 90 is configured to synchronize respective readout regions 52 on a sensor surface 58 of the camera 50 with a position of the excitation light 12 in the sample region as defined by the scanning unit 20. Finally, according to the invention, for the purpose of varying an axial pose z0, z1, z2 of a plane in the sample 1 (see FIG. 2) optically conjugate to a sensor surface 58 of the camera 50, the detection beam path comprises a controllable optics unit with variable refractive power 32, which is effective for the entire emission light 36 that has propagated in the detection beam path to the camera 50.

In the exemplary embodiment in FIG. 1, the microscope 100 comprises a microscope stand 60 having the microscope objective 40 and a tube lens 26. An intermediate image plane 24 is provided by the tube lens 26. Furthermore, in the exemplary embodiment shown, the cylindrical optics unit 18, the scanning unit 20, a main beam splitter 30, a scanning optics unit 22, the optics unit with variable refractive power 32 and the camera 50 are accommodated in an illumination/detection module 62, which is mechanically coupled to a camera port (not illustrated in the figure) of the microscope stand 60 by way of means that are not shown in specific detail. In the exemplary embodiment in FIG. 1, the illumination beam path and the detection beam path thus comprise the common tube lens 26, and the excitation light 12 and the emission light 36 pass through the same intermediate image plane 24.

An optical axis 41 of the microscope objective 40 extends in the z-direction. An x-y displacement stage (not illustrated) is present for positioning the sample 1 in the directions x, y that are perpendicular to the optical axis 41 and to each other. This manipulation possibility is indicated by the double-headed arrow 42. A z-drive or focus drive, likewise not illustrated, is present for modifying an axial distance of the sample 1, i.e. in the direction of the optical axis 41, relative to the microscope objective 40. The double-headed arrow 43 represents this manipulation possibility.

In the exemplary embodiment in FIG. 1, the control unit 90 is also configured for controlling the light source 10, the controllable optics unit with variable refractive power 32, the x-y displacement stage and the z-drive. The control unit 90 is suitably operatively connected, typically via cables not illustrated in FIG. 1, to those components that it is configured to control and whose measurement data it evaluates.

The light source 10 can be realized by a laser module, for example. The excitation light 12 supplied by the light source 10 passes via an optional zoom optics unit 14, which serves for setting a beam diameter, as a collimated beam to the cylindrical optics unit 18 present according to the invention, said cylindrical optics unit comprising a first cylindrical lens 17. In addition, an optional second cylindrical lens 16 is present, the function of which will be explained further below. The first cylindrical lens 17 has the effect of focusing the excitation light 12 in the x-direction to form an illumination line extending in the y-direction. Via the scanning unit 20, which can be realized for example by a scanner mirror pivotable about an axis of rotation parallel to the x-axis, the excitation light 12 then passes via the main beam splitter 30 to the scanning optics unit 22, which can be a spherical lens, for example. Furthermore, the excitation light 12 passes via the tube lens 26, which is likewise a spherical lens, into the microscope objective 40 and is guided by the latter as intended into the sample region 1. The scanning unit 20 is arranged in a pupil plane, that is to say in a plane which is optically conjugate to a back focal plane 28 of the microscope objective 40.

The light distribution provided by the cylindrical optics unit 18, hence the illumination line, is converted by the scanning optics unit 22 into a linear focus in the intermediate image plane 28 that extends in the x-direction. The scanning carried out by the scanning unit 20, illustrated by the curved double-headed arrow at the scanning unit 20, then takes place perpendicular to the linear light distribution in the intermediate image plane 24, that is to say that the linear focus is moved up and down in the y-direction during scanning in the intermediate image plane 24 and thus in the sample region 1.

Emission light 36 emitted by the sample 1 as a consequence of irradiation with the excitation light 12, said emission light in the example shown being fluorescence from dyes used to prepare the sample 1, accordingly again has a linear distribution in the intermediate image plane 24. The emission light 36, which is red-shifted in comparison with the excitation light 12, is transmitted by the main beam splitter 30, for example a dichroic beam splitter, and then passes via the settable optics unit with variable refractive power 32, which is present according to the invention, to a camera lens 34, which images the linear distribution of the emission light 36 into a region 54 on a sensor surface 58 of the camera 50 (FIG. 3).

The respective readout region 52 on the sensor surface 58 of the camera 50 is synchronized by the control unit 90 with a position—defined by the scanning unit 20—of the excitation light 12 in the sample region 1 and thus the position of the linear distribution of the emission light 36 in the region 54. A direction 56 of movement and speed of movement of the readout region 52 therefore correspond to the direction and speed with which the linear focus of the excitation light 12 is guided along the y-direction through the sample region 1.

In the exemplary embodiment shown, the settable optics unit with variable refractive power 32 is realized by an ETL (ETL=electronically tunable lens) positioned in a pupil plane 33 of the detection beam path between the main beam splitter 30 and the camera lens 34. The refractive power of the ETL is defined by an electrical voltage present at its contacts. Typical refractive power variations are for example +/−2 dpt (dpt=dioptre=1/m). The ETL thus makes it possible to displace the plane in the sample region that is optically conjugate to the plane of the camera sensor 58 by approximately +/−10 micrometres in the case of a 20× objective. The usable range would be approximately +/−5 micrometres in the case of a 40× objective. That is in each case significantly more than +/−2 optical depths of field of the detection beam path and is thus sufficient for scanning the sample region 1 axially, i.e. at different depths in the z-direction, in the range of high power densities of the linear focus of the excitation light 12. This is illustrated schematically in FIG. 2, which depicts the microscope objective 40 and a sample 1. As a result of the effect of the ETL, the focal region imaged onto the sensor plane 58 of the camera 50 can be adjusted in the range between the axial planes z1 and z2. z0 denotes a central plane. The entire axial shift Δz possible is evidently a multiple of the optical depth of field δz of the detection beam path. In the exemplary embodiment in FIG. 1, the feature whereby the controllable optics unit with variable refractive power 32 is effective for the entire emission light 36 that has propagated in the detection beam path to the camera 50 means that the entire emission light 36 that reaches the camera 50 passes through the ETL 32.

During a three-dimensional image recording of samples having a thickness that is larger than the effective region of the ETL, the setting of the focal plane by the ETL 32 can be coordinated with the movement of the focus drive 43 by the control unit 90. If an axial shift Δz of two optical depths of field δz is assumed, for each position of the focus drive six image positions can be moved to by the ETL 32. Given a latency of 500 ms, that adds up to a time saving of 3 s in comparison with the situation in which the planes are moved to only by the focus drive.

In one variant, a spherical lens can be arranged between the cylindrical optics unit 18 and the scanning unit 20, and generates an intermediate image plane in which the linear light distribution generated by the cylindrical optics unit 18 is then situated. That has the advantage that the field illumination can be set by a telescope disposed upstream of the cylindrical optics unit 18, which is otherwise determined by the numerical aperture of the cylindrical optics unit 18. Alternatively, a settable stop for setting a numerical aperture of the cylindrical optics unit could also be present in the illumination beam path upstream of the cylindrical optics unit 18 or a field stop could be arranged in the intermediate image plane provided by the spherical lens.

For use in the slide scanner, an optimum focus position could be determined when setting up the scan at some distinguished locations of a region to be scanned and a focus setting map could be generated by interpolation. This map could be used when moving to a new partial image position in order to move to the optimum focus position for the partial image by means of the ETL.

In order to extend the axial working range of the microscope or even to be able to make it settable, the length of the linear light distribution in the back focal plane 28 of the microscope objective 40 can be influenced by a motor-settable stop, not illustrated. If the length of the linear light distribution is reduced, the axial extent of the linear focus in the sample region 1 and thus the region that is expediently scannable by the ETL are enlarged. Although that is detrimental to the achievable lateral resolution, that may be an expedient compromise for some applications. Such a stop could be arranged for example in the laser-side focal plane of the cylindrical optics unit 18.

In the exemplary embodiment shown in FIG. 1, a second cylindrical lens 16 is present, which is optionally removable from the beam path and which causes a slight focusing in the y-direction, with the result that the length of the linear light distribution in the back focal plane 28 of the microscope objective is reduced.

It is also possible to introduce an optics unit with variable refractive power, for example an ETL, upstream of the main beam splitter 30 in the illumination beam path and to operate said optics unit with variable refractive power in a manner synchronized with the ETL 32 in the detection arm.

An additional extension of the axial working range is possible if the optics unit with varying refractive power 32 is moreover capable of correcting further aberrations, in particular spherical aberrations. For example, this is possible using spatial light modulators (SLMs) and/or adaptive lenses. Using such arrangements, it is possible in particular to correct spherical aberrations arising due to the defocusing, and larger axial displacements of the observed sample plane can be expediently realized.

A linear point spread function (PSF) of the illumination beam path and a punctiform point spread function of the detection beam path can be measured and deconvolved from the measurement data of the camera 50 using deconvolution algorithms that are known in principle.

An alternative of an illumination/detection module 63 for a microscope according to the invention will be explained with reference to FIG. 4. Only the differences in comparison with the illumination/detection module 62 in FIG. 1 will be explained here.

Firstly, a spherical lens 19 is present in the illumination beam path between the cylindrical optics unit 18 and the scanning unit 20, and provides an intermediate image plane 15, i.e. a plane optically conjugate to the illuminated plane in the sample region 1. Arranged in this intermediate image plane 15 is a spatial light modulator 70, for example a phase-modulating SLM, which can modulate the illumination light 12 in the back focal plane 28 of the microscope objective 40, for example for structured illumination microscopy (SIM).

In the detection beam path, in comparison with FIG. 1, the ETL 32 is arranged slightly offset from the pupil plane 33 and a detection scanning unit 72 is additionally present, which is likewise arranged in the vicinity of the pupil plane 33. The pupil plane 33 and the pupil plane (without a reference sign) in which the scanning unit 20 is arranged are each situated at the same distance d from the main beam splitter 30.

The detection scanning unit 72 is realized by a scanner that is pivotable about an axis of rotation running parallel to the x-axis and is controlled by the control unit 90 in a manner synchronized with the scanning unit 20 and the camera 50. The scanners of the scanning unit 20 and/or of the detection scanning unit 72 can be galvanometric scanners or a MEMS scanner.

In one advantageous method variant, the detection scanning unit 72 is operated fully synchronously with the scanning unit 20, i.e. at the same speed and with the same phase angle as the scanning unit. As a result of the actuation of the detection scanning unit 72, the imaging of a region irradiated by the linear illumination on the sensor surface 58 of the camera 50 is drawn up in the y-direction and in this sense is non-optically enlarged in the y-direction.

Particularly preferably, the enlargement provided by the detection beam path and in particular by the detection scanning unit 72 is large enough overall that measurement data from camera pixels in a direction transverse to the direction of extent of the linear distribution 54 of the emission light 36, hence in the x-direction, are evaluable using methods which substantially correspond to image scanning methods, i.e. pixel reassignment methods.

In preferred variants of the method according to the invention, the excitation light 12 is modulated along the direction of extent of the linear illumination with the aid of the spatial light modulator 70, and measurement data of the camera pixels in the direction of the direction of extent of the linear illumination are evaluated using SIM evaluation methods, and measurement data of the camera pixels in a direction transverse to the direction of extent of the linear illumination are evaluated in an image scanning method.

The invention presents a novel microscope and a novel method which enable particularly fast confocal 3D microscopy. A fast imaging method for creating optical sections for fluorescence microscopy is thereby provided.

### LIST OF REFERENCE SIGNS

1 sample
10 light source, laser
12 excitation light
14 zoom optics unit, telescope optics unit (optional)
15 intermediate image plane
16 cylindrical lens (optional)
17 cylindrical lens
18 cylindrical optics unit
19 spherical lens (optional)
20 scanning unit, for example MEMS scanner, or galvo scanner
30 main beam splitter
22 scanning optics unit
24 intermediate image plane
26 tube lens
28 pupil plane of microscope objective 40
30 main beam splitter
32 settable lens, for example ETL
33 pupil plane
34 camera lens
36 emission light radiated by sample 1 as a consequence of illumination with excitation light 12, fluorescence
40 microscope objective 40
42 adjustment possibility in x- and y-direction, for example with x-y displacement stage
43 axial adjustment possibility, for example with z-drive of the microscope objective 40
44 immersion liquid (optional)
50 camera
52 readout region of sensor surface 58
54 region optically conjugate with illuminated linear region in sample 1
56 direction of movement of the readout region 52
58 sensor surface of the camera 50
60 microscope stand
62 illumination/detection module
63 illumination/detection module
70 spatial light modulator
72 scanning unit, for example MEMS scanner
90 control unit, for example PC, for controlling the scanner 20 and the camera 50 and for evaluating measurement data from the camera 50
d distance between scanning unit 20 and main beam splitter 30 and distance between pupil plane 33 and main beam splitter 30
x, y, Z right-handed orthogonal coordinate system
z0 central plane in sample 1
z1 first plane in sample 1
z2 second plane in sample 1
Δz possible axial shift
δz optical depth of field of the detection beam path

### REFERENCES

WO 2023117236 A1
[MAC2022] Khuong Duy Mac, Muhammad Mohsin Qureshi, Myeongsu Na, Sunghoe Chang, Tae Joong Eom, Hyunsoo Shawn Je, Young Ro Kim, Hyuk-Sang Kwon, and Euiheon Chung
Fast volumetric imaging with line-scan confocal microscopy by electrically tunable lens at resonant frequency
Opt Express. 2022 May 23; 30(11): 19152-19164.

1. Microscope comprising:
a light source for transmitting excitation light,
an illumination beam path having an illumination objective for guiding the excitation light onto or into a sample,
the illumination beam path comprising a cylindrical optics unit for shaping the excitation light to form an illumination line and a scanning unit for linearly scanning the sample with the excitation light,
a detection beam path having a microscope objective for guiding emission light radiated by the sample onto a camera,
the camera for recording images of the sample, and
a control unit for controlling at least the scanning unit and/or the camera and for evaluating measurement data from the camera,
the control unit being configured to synchronize respective readout regions on a sensor surface of the camera with a position of the excitation light in a sample region as defined by the scanning unit,
wherein for varying an axial pose of a plane in the sample optically conjugate to a sensor surface of the camera,
the detection beam path comprises a controllable optics unit with variable refractive power, which is effective for the entire emission light that has propagated in the detection beam path to the camera.

2. Microscope according to claim 1,
wherein the optics unit with variable refractive power is arranged in a pupil plane or in the vicinity of a pupil plane.

3. Microscope according to claim 1,
wherein the optics unit with variable refractive power comprises one or more of the following components or is formed by one or more of the following components: controllable gravity-compensated liquid lens, controllable deformable mirror, electronically tunable lens, adaptive lens, spatial light modulator.

4. Microscope according to claim 1,
wherein the optics unit with variable refractive power enables varying the axial pose of an imaging region of the detection beam path in the sample region by more than four times a depth of field of the detection beam path in the sample region.

5. Microscope according to claim 1,
wherein the illumination beam path and the detection beam path comprise a common tube lens and wherein the excitation light and the emission light pass through the same tube lens.

6. Microscope according to claim 1,
wherein the cylindrical optics unit, the scanning unit, a main beam splitter, a scanning optics unit, the optics unit with variable refractive power and the camera are arranged in an illumination/detection module coupled to a camera port of a microscope stand, the microscope stand comprising the microscope objective and a tube lens.

7. Microscope according to claim 1,
wherein a settable stop for setting a numerical aperture of the cylindrical optics unit is present upstream of the cylindrical optics unit in the illumination beam path.

8. Microscope according to claim 1,
wherein the cylindrical optics unit comprises at least one further cylindrical lens that is optionally introducible into the beam path and that serves to reduce a length of the linear focal region in its direction of extent.

9. Microscope according to claim 1,
wherein the illumination beam path comprises a settable stop for setting a length of the linear focal region in its direction of extent.

10. Microscope according to claim 1,
wherein the cylindrical optics unit generates a linear illumination in a back focal plane of the microscope objective.

11. Microscope according to claim 1,
wherein the illumination beam path between the cylindrical optics unit and the scanning unit comprises a spherical lens.

12. Microscope according to claim 1,
wherein a field stop is arranged in an intermediate image plane provided by the spherical lens.

13. Microscope according to claim 1,
wherein the illumination beam path upstream of the cylindrical optics unit comprises a settable telescope optics unit or a zoom optics unit for setting a field size or for setting an illumination of the cylindrical optics unit.

14. Microscope according to claim 1,
wherein a spatial light modulator for modulating the excitation light in the back focal plane of the microscope objective is arranged in the illumination beam path in an intermediate image plane.

15. Microscope according to claim 1,
wherein the detection beam path in a pupil plane or in the vicinity of a pupil plane comprises a detection scanning unit that is synchronized with the scanning unit and the camera.

16. Microscope according to claim 15,
wherein an enlargement of the detection beam path provided by the detection scanning unit is large enough that measurement data from camera pixels in a direction transverse to the direction of extent of the linear distribution of the emission light are evaluable using image scanning methods.

17. Microscope according to claim 1,
wherein at least one of the scanners of the scanning unit and/or of the detection scanning unit is a galvanometric scanner or a MEMS scanner.

18. Microscope according to claim 1,
wherein a controllable x-y displacement stage, on which the sample is arrangeable, is present for laterally varying a position of the sample relative to the microscope objective,
wherein the control unit is configured for controlling the x-y displacement stage, and
wherein the control device is configured,
for a plurality of positions of the x-y displacement stage, to record an overview image of a sample composed of individual images and to assign to each individual image or to individual x-y positions therein a setting for the optics unit with variable refractive power, said setting being determined on the basis of image data of the relevant individual image.

19. Slide reader having a microscope according to claim 1.

20. Method for microscopy, comprising:
linearly illuminating and scanning a sample with excitation light by an illumination objective,
guiding emission light radiated by the sample as a consequence of being illuminated with the excitation light in the direction of a camera via a microscope objective,
recording images of the sample by the camera,
wherein respective readout regions on a sensor surface of the camera are synchronized with a position of the excitation light on the sample,
setting an axial pose of a plane in the sample optically conjugate to a sensor surface of the camera by a controllable optics unit with variable refractive power, which is effective for the entire emission light that has propagated to the camera.

21. Method according to claim 20,
wherein a focus setting map is determined, which in each case assigns x-y positions in an imaged field to a setting of the optics unit with variable refractive power by virtue of the fact that, for x-y positions which lie between the positions for which a setting for the optics unit with variable refractive power that has been determined on the basis of an overview image is present, a setting for the optics unit with variable refractive power is interpolated from values for adjacent x-y positions for which settings for the optics unit with variable refractive power that have been determined from the overview image are present.

22. Method according to claim 20,
wherein a detection scanning unit in the detection beam path is operated in a manner synchronized with the scanning unit and the camera.

23. Method according to claim 22,
wherein the detection scanning unit is operated at the same speed and with the same phase angle as the scanning unit.

24. Method according to claim 20,
wherein the excitation light is modulated along the direction of extent of the linear illumination,
wherein measurement data of the camera pixels in the direction of the direction of extent of the linear illumination are evaluated by evaluation methods of structured illumination microscopy, and
wherein measurement data of the camera pixels in a direction transverse to the direction of extent of the linear illumination are evaluated in an image scanning method.
